(19) United States
(12) Patent Application Publication
(10) Pub. No.: US 2025/0136787 A1
(43) Pub. Date: May 1, 2025

(54) POLYESTER RESIN COMPOSITION

(71) Applicant: TOYOBO MC Corporation, Osaka (JP)

(72) Inventors: Kaori FURUKAWA, Otsu-shi, Shiga (JP); Yoshitaka AYUZAWA, Shiga (JP); Takahiro SHIMIZU, Shiga (JP)

(73) Assignee: TOYOBO MC Corporation, Osaka (JP)

(21) Appl. No.: 18/835,861

(22) PCT Filed: Feb. 1, 2023
(86) PCT No.: PCT/JP2023/003262

§ 371 Date: Aug. 5, 2024

(30) Foreign Application Priority Data
Feb. 7, 2022 (JP) 2022-017526

(51) Int. Cl. C08K 5/103; C08G 63/183

(52) U.S. Cl. CPC C08K 5/103; C08G 63/183

(57) ABSTRACT

The present invention provides a polyester resin composition that is capable of producing a molded product that can have a complex and/or partially-thin shape but still sufficient in mold releasability and also reduced in fogging and/or bleeding out, and the polyester resin composition comprises 0.01 to 4 parts by mass of a mold release agent (B) relative to 100 parts by mass of a polyalkylene terephthalate resin (A), wherein the mold release agent (B) contains two or more fatty acid ester compounds each consisting of a polyhydric aliphatic alcohol and a fatty acid. Preferably, the mold release agent (B) includes a fatty acid ester compound (B1) consisting of a hexahydric aliphatic alcohol and a fatty acid having 5 to 30 carbon atoms as well as a fatty acid ester compound (B2) consisting of a dihydric to tetrahydric aliphatic alcohol and a fatty acid having 5 to 30 carbon atoms.

### TECHNICAL FIELD

The present invention relates to a polyester resin composition, and more specifically, it relates to a polyester resin composition that has good mold releasability, low-fogging properties, and excellent bleeding-out resistance.

### BACKGROUND ART

Polybutylene terephthalate is a leading engineering plastic among other thermoplastic polyesters, and because of its excellent moldability, mechanical strength, heat resistance, chemical resistance, and electric properties, it is widely used in injection molding of automobile parts, electrical and electronic components, and the like.

However, polybutylene terephthalate can sometimes adhere to the mold as it shrinks, and cannot be removed from the mold. For this reason, a mold release agent such as paraffin oil, aliphatic metal soap, and/or long-chain aliphatic ester is often added to polybutylene terephthalate to improve sliding on the mold.

In recent years, in accordance with the trend toward smaller size of automobile parts and electrical/electronic components, it is often the case that the shape of molded products is complex and/or partially thin, which can cause a mold release failure at the time of molding, potentially leading to deformation, poor appearance, and/or breakage of molded products. When the amount of mold release agents is increased for the purpose of reducing the incidence of mold release failures, gas can be produced, potentially causing problems such as remaining residues on the mold and/or in the dryer and bleeding out.

PTL 1 suggests that it is possible to reduce gas production and/or bleeding out by blending polybutylene terephthalate with an aliphatic ester having a particular molecular weight and consisting of a trihydric to hexahydric aliphatic alcohol and a fatty acid, but PTL 1 does not discuss mold releasability.

PTL 2 suggests a composition that has mold releasability and low-fogging properties produced by blending polybutylene terephthalate with an aliphatic ester consisting of a trihydric to hexahydric aliphatic alcohol and a fatty acid as well as an olefin-based elastomer. PTL 3 suggests a composition that has mold releasability and low-fogging properties produced by blending polybutylene terephthalate with a particular copolymerized polybutylene terephthalate as well as an aliphatic ester consisting of a trihydric to hexahydric aliphatic alcohol and a fatty acid. All of these PTLs merely suggest using a particular component and a fatty acid ester in combination to reduce deposition of a degradation product of the fatty acid ester on the surface and thereby enhance low-fogging properties, but none of them mention enhancement of mold releasability.

PTL 4 suggests a composition that has mechanical properties and excellent fluidity produced by blending polybutylene terephthalate with a glycerol fatty acid ester having a high hydroxy value as well as a polyhydric alcohol fatty acid ester having a low hydroxy value, but it does not mention mold releasability, low-gas properties, or low-fogging properties.

PTL 5 suggests a polyester resin composition that can have enhanced mold releasability and enhanced low-fogging properties produced by using, together with a polyester resin, a combination of a fatty acid glycerol triester having a high mold releasability and a fatty acid glycerol monoester having a great level of internal sliding effect, but the enhancement of mold releasability is achieved by the increased total amount of the glycerol fatty acid ester components.

### CITATION LIST

### Patent Literature

PTL 1: Japanese Patent Laying-Open No. 2017-179204
PTL 2: Japanese Patent Laying-Open No. 2019-59801
PTL 3: Japanese Patent Laying-Open No. 2020-105311
PTL 4: Japanese Patent Laying-Open No. 2017-101108
PTL 5: Japanese Patent Laying-Open No. 2005-97563

### SUMMARY OF INVENTION

### Technical Problem

In light of these circumstances, the present invention aims at providing a polyester resin composition that is capable of producing a molded product that can have a complex and/or partially-thin shape but still sufficient in mold releasability and also reduced in fogging and/or bleeding out.

### Solution to Problem

The inventors of the present invention have conducted intensive research on the configuration and properties of polyester resin compositions for the purpose of achieving the above-described object, and, as a result, have found that it is possible to achieve the above-described object by blending two or more particular mold release agents and thereby obtaining a synergistic effect of enhancing mold releasability. Thus, the present invention has now been completed.

More specifically, the present invention has the configurations presented below.

[1] A polyester resin composition comprising 0.01 to 4 parts by mass of a mold release agent (B) relative to 100 parts by mass of a polyalkylene terephthalate resin (A), wherein the mold release agent (B) contains two or more fatty acid ester compounds each consisting of a polyhydric aliphatic alcohol and a fatty acid.

[2] The polyester resin composition according to [1], wherein the mold release agent (B) includes a fatty acid ester compound (B1) consisting of a hexahydric aliphatic alcohol and a fatty acid having 5 to 30 carbon atoms as well as a fatty acid ester compound (B2) consisting of a dihydric to tetrahydric aliphatic alcohol and a fatty acid having 5 to 30 carbon atoms.

[3] The polyester resin composition according to [2], wherein the fatty acid ester compound (B1) has a weight decrement rate at 300° C. in thermogravimetric analysis of 4.5% or less.

[4] The polyester resin composition according to [2] or [3], wherein the fatty acid ester compound (B2) has a weight decrement rate at 300° C. in thermogravimetric analysis of 1.5% or less.

[5] The polyester resin composition according to any one of [2] to [4], wherein the fatty acid ester compound (B2) is a fatty acid ester compound consisting of glycerol and a fatty acid having 5 to 30 carbon atoms.

[6] The polyester resin composition according to [5], wherein the fatty acid ester compound (B2) is a fatty acid triester compound consisting of glycerol and a fatty acid having 12 to 30 carbon atoms.

[7] The polyester resin composition according to any one of [2] to [6], wherein the fatty acid ester compound (B1) is a fatty acid ester compound consisting of dipentaerythritol or tetraglycerol and a fatty acid having 5 to 30 carbon atoms.

[8] The polyester resin composition according to [7], wherein the fatty acid ester compound (B1) is a fatty acid hexaester compound consisting of dipentaerythritol and a fatty acid having 12 to 30 carbon atoms.

### Advantageous Effects of Invention

According to the present invention, it is possible to provide a polyester resin composition that has excellent mold releasability due to the synergistic effect of enhancing mold releasability exhibited by a combined use of mold release agents, that has less residues left in a dryer and/or on a mold due to reduction of gas production at the time of drying and/or at the time of molding, and that also has excellent low-fogging properties and/or excellent bleeding-out resistance.

### BRIEF DESCRIPTION OF DRAWINGS

FIG. 1 gives schematic views of a molded product subjected to mold releasability evaluation, where [X] is viewed from a side, [Y] is viewed from the bottom, and [Z] is viewed from the movable side of the mold.

### DESCRIPTION OF EMBODIMENTS

In the following, the present invention will be described in detail.

A polyalkylene terephthalate resin (A) used in the present invention is a thermoplastic polyester that is obtained by a typical polymerization reaction, such as polycondensation reaction, of a dicarboxylic acid component containing as a main component a dicarboxylic acid compound and/or an ester-forming derivative thereof and a diol component containing as a main component a diol compound and/or an ester-forming derivative thereof, where the dicarboxylic acid component contains as a main component terephthalic acid and/or an ester-forming derivative thereof and the diol component contains as a main component an alkylene glycol and/or an ester-forming derivative thereof. Herein, the alkylene glycol is preferably an alkylene glycol having 2 to 8 carbon atoms. Specific examples include ethylene glycol, trimethylene glycol, 1,2-propylene glycol, 1,4-butanediol, 1,3-butanediol, neopentyl glycol, 1,6-hexanediol, 1,4-cyclohexanediol, and 1,4-cyclohexanedimethanol; one of them is preferable, and among them, one of ethylene glycol, trimethylene glycol, and 1,4-butanediol is more preferable.

Preferably, terephthalic acid and/or an ester-forming derivative thereof is contained in an amount of 80 mol % or more per 100 mol % of the dicarboxylic acid component, more preferably 90 mol % or more, further preferably 95 mol % or more, optionally 100 mol %. Preferably, an alkylene glycol and/or an ester-forming derivative thereof is contained in an amount of 80 mol % or more per 100 mol % of the diol component, more preferably 90 mol % or more, further preferably 95 mol % or more, optionally 100 mol %.

As a dicarboxylic acid component other than the main component (terephthalic acid), namely as a copolymerization component, mention may be made of an aliphatic dicarboxylic acid (such as adipic acid, sebacic acid, or decanedicarboxylic acid, for example), an alicyclic dicarboxylic acid (such as hexahydrophthalic acid, hexahydroisophthalic acid, or hexahydroterephthalic acid, for example), an aromatic dicarboxylic acid except for terephthalic acid (such as isophthalic acid, a naphthalene dicarboxylic acid such as 2,6-naphthalene dicarboxylic acid, or 4,4′-biphenyldicarboxylic acid, for example), or a derivative of them (such as a derivative capable of forming an ester such as a lower alkyl ester, an aryl ester, and an acid anhydride, for example). One type of these copolymerization components may be used by itself, or two or more types of them may be used.

A diol component other than the diol component used as a main component may be used as a copolymerization component. A diol component that may be used are as listed above. One type of the copolymerization components may be used by itself, or two or more types may be used. As a copolymerization component, a condensation product of the diol component which can be produced as a by-product during polymerization (which is, for example, diethylene glycol and/or the like derived from ethylene glycol) may be included.

Examples of a preferable polyalkylene terephthalate resin (A) include homopolyesters such as polyethylene terephthalate (PET), polytrimethylene terephthalate (PTT), and polybutylene terephthalate (PBT), and copolyesters that contain the above-mentioned copolymerization component; one type of them can be used by itself or two or more types of them can be used in combination. Among these, as the polyalkylene terephthalate resin (A), one or more types selected from polyethylene terephthalate (PET), polytrimethylene terephthalate (PTT), and polybutylene terephthalate (PBT) are preferable.

As an index of the molecular weight of the polyalkylene terephthalate resin (A), the reduced viscosity may be used (which is measured with an Ubbelohde viscometer tube at 30° C., using 0.1 g of the resin dissolved in 25 ml of a mixed solvent of phenol/tetrachloroethane (mass ratio, 6/4)). The reduced viscosity of the polyalkylene terephthalate resin (A) is preferably within the range of 0.3 to 1.6 dl/g, more preferably within the range of 0.45 to 1.35 dl/g. With the reduced viscosity of the polyalkylene terephthalate resin being from 0.3 to 1.6 dl/g, a polyalkylene terephthalate resin composition according to the present invention has good mechanical properties and good moldability.

Furthermore, the polyalkylene terephthalate resin (A) can be used together with other thermoplastic resins, as long as an object of the present invention is not impaired. When other thermoplastic resins are used, the amount of these other thermoplastic resins to be used is not particularly limited as long as an object of the present invention is not impaired, and, typically, it is preferably 100 parts by mass or less, more preferably 80 parts by mass or less, particularly preferably 50 parts by mass or less, relative to 100 parts by mass of the polyalkylene terephthalate resin (A).

Specific examples of other preferable resins that can be used in the present invention include polyolefins such as polyethylene and polypropylene; polyamide resins such as nylon 46, nylon 6, nylon 66, nylon 610, nylon 612, nylon 11, nylon 12, and MXD nylon; polystyrene; polyvinyl chloride; polyacrylonitrile; cyclic-olefin-based resins such as cyclic olefin polymers and cyclic olefin copolymers; acrylic resins; polycarbonate resins; AS resin; ABS resin; acetal resins such as polyoxymethylene; polyphenylene oxide; polyphenylene sulfide resins such as polyphenylene sulfide, polyphenylene sulfide ketone, polybiphenylene sulfide, and polyphenylene sulfide sulfone; polysulfone resins such as poly(ether sulfone) and poly(4,4′-bisphenol ether sulfone); polyether ketone resins; polyether ether ketone resins; liquid crystal polymers; fluororesins; and the like. Two or more types of these other thermoplastic resins can be used.

A mold release agent (B) used in the present invention includes a fatty acid ester compound that is composed of a polyhydric aliphatic alcohol and a fatty acid. In the present invention, two or more types of the aliphatic ester compound are used. Preferably, the fatty acid ester has not been partially saponified from the viewpoint of reduction of bleeding out, and in the present invention, a partially saponified product is not categorized as a fatty acid ester compound.

Examples of the polyhydric aliphatic alcohol include ethylene glycol, glycerol, 1,2,4-butanetriol, diglycerin, erythritol, pentaerythritol, sorbitol, triglycerol, dipentaerythritol, tetraglycerol, and the like. One type of these polyhydric aliphatic alcohols can be used by itself, or two or more types of them can be used in combination. As the polyhydric aliphatic alcohol, a trihydric to hexabydric aliphatic alcohol is preferable, and, for example, glycerol and/or dipentaerythritol is particularly preferable.

As the fatty acid, a linear or branched saturated fatty acid having 5 to 30 carbon atoms is preferable, and examples thereof include pentanoic acid, hexanoic acid, octanoic acid, nonanoic acid, decanoic acid, lauric acid, oleic acid, myristic acid, palmitic acid, stearic acid, isostearic acid, 12-hydroxystearic acid, arachidic acid, behenic acid, lignoceric acid, cerotic acid, montanic acid, melissic acid, and the like.

Among fatty acid ester compounds that are composed of the above-mentioned polyhydric aliphatic alcohols and the above-mentioned fatty acids, for the purpose of obtaining a synergistic mold-releasability effect, a fatty acid ester compound (B1) consisting of a hexabydric aliphatic alcohol and a fatty acid having 5 to 30 carbon atoms and a fatty acid ester compound (B2) consisting of a dihydric to tetrahydric aliphatic alcohol and a fatty acid having 5 to 30 carbon atoms is preferably included.

The reason why such a synergistic effect is exhibited when compounds having the above-mentioned particular structures are used in combination is not clear, but a potential reason is as follows.

The fatty acid ester compound (B1) is an ester compound and has a certain degree of compatibility with the polyalkylene terephthalate resin (A), while it also has many hydrophobic groups (having 5 to 30 carbon atoms) and therefore has a strong tendency to be localized in the outermost layer of the molded product, greatly contributing to mold releasability. Meanwhile, due to its not-so-high compatibility with the polyalkylene terephthalate resin (A), when molecular motion of the fatty acid ester compound (B1) becomes activated at high temperatures, it tends to be released out of the system in the form of gas to cause fogging.

The fatty acid ester compound (B2) is also an ester compound and compatible with the polyalkylene terephthalate resin (A), but it does not have as many hydrophobic groups (having 5 to 30 carbon atoms) as those in the fatty acid ester compound (B1), so it becomes localized near the surface layer of the molded product but not in the outermost layer, and therefore it does not greatly contribute to mold releasability. Meanwhile, due to its high compatibility with the polyalkylene terephthalate resin (A) as compared to that of the fatty acid ester compound (B1), even when the molecular motion of the fatty acid ester compound (B2) becomes activated at high temperatures, it tends to remain in the resin and not released out of the system that much.

Because the fatty acid ester compound (B1) and the fatty acid ester compound (B2) have similar structures to each other, they are expected to interact with each other. When the fatty acid ester compound (B1) and the fatty acid ester compound (B2) coexist, the fatty acid ester compound (B1) becomes localized in the outermost layer of the molded product to greatly contribute to mold releasability, while the fatty acid ester compound (B2) that is present near the surface layer offsets the lack of compatibility between the polyalkylene terephthalate resin (A) and the fatty acid ester compound (B1) to reduce the release of the fatty acid ester compound (B1) out of the system. Hence, it is conceivable that the combined use of these fatty acid ester compounds makes it possible to obtain the synergistic effect, the highest possible mold releasability, and remarkable improvement in low-fogging properties.

As the hexabydric aliphatic alcohol of the fatty acid ester compound (B1), dipentaerythritol, tetraglycerol, and/or the like may be mentioned, and dipentaerythritol is preferable. As the fatty acid having 5 to 30 carbon atoms of the fatty acid ester compound (B1), a fatty acid having 12 to 30 carbon atoms is preferable, and a fatty acid having 18 to 28 carbon atoms is more preferable. This fatty acid may be substituted with a hydroxy group and/or the like.

The fatty acid ester compound (B1) is preferably a fatty acid ester compound consisting of dipentaerythritol or tetraglycerol and a fatty acid having 5 to 30 carbon atoms, more preferably a fatty acid hexaester compound consisting of dipentaerythritol and a fatty acid having 12 to 30 carbon atoms.

As the dibydric to tetrahydric aliphatic alcohol of the fatty acid ester compound (B2), ethylene glycol, glycerol, 1,2,4-butanetriol, diglycerin, erythritol, pentaerythritol, and the like may be mentioned, and preferable among them are glycerol and pentaerythritol, more preferable is glycerol. As the fatty acid having 5 to 30 carbon atoms of the fatty acid ester compound (B2), a fatty acid having 12 to 30 carbon atoms is preferable, a fatty acid having 12 to 28 carbon atoms is more preferable. This fatty acid may be substituted with a hydroxy group and/or the like.

Preferably, the polyester resin composition according to the present invention contains two or more types of fatty acid ester compounds blended together, and one of them, namely the fatty acid ester compound (B1) has a weight decrement rate at 300° C. in thermogravimetric analysis (where 10 mg of the sample is measured in a weight detection mode at 20° C./minute) of 4.5% or less from the viewpoints of less residues left on the mold and/or in the dryer, low-fogging properties, bleeding-out resistance, and the like, and from the same reason, it is preferable that the fatty acid ester compound (B2) have a weight decrement rate at 300° C. in thermogravimetric analysis (where 10 mg of the sample is measured in a weight detection mode at 20° C./minute) of 1.5% or less.

Furthermore, the fatty acid ester compound (B2) used in the present invention is preferably a fatty acid ester compound consisting of glycerol and a fatty acid having 5 to 30 carbon atoms, and from the viewpoint of mold releasability, it is more preferably a fatty acid triester compound consisting of glycerol and a fatty acid having 12 to 30 carbon atoms.

The total content of the component (B) is from 0.01 to 4 parts by mass relative to 100 parts by mass of the polyalkylene terephthalate resin (A). When the content of the component (B) is 0.01 parts by mass or more, mold releasability tends to be good, and when it is 4 parts by mass or less, less residues tend to be left on the mold and/or in the dryer as well as fogging and bleeding out tend to be reduced. The lower limit to the content is preferably 0.1 parts by mass or more, more preferably 0.2 parts by mass or more, further preferably 0.3 parts by mass or more. The upper limit to the content is preferably 3.5 parts by mass or less, more preferably 2 parts by mass or less, further preferably 1 part by mass or less, particularly preferably 0.6 parts by mass or less. As for the mass ratio between the fatty acid ester compound (B1) and the fatty acid ester compound (B2) in the component (B), the component (B1) is preferably from 40 to 90 mass % relative to the total of the component (B1) and the component (B2), more preferably from 45 to 80 mass %.

As long as an object of the present invention is not impaired, the resin composition according to the present invention may contain a mold release agent other than a fatty acid ester compound consisting of a polyhydric aliphatic alcohol and a fatty acid.

In addition, as long as the properties of the present invention are not impaired, the resin composition according to the present invention may contain various known additives, as needed. Examples of the known additives include a colorant such as a pigment, a reinforcing material, an anti-heat stabilizer, an antioxidant, an ultraviolet absorber, a light stabilizer, a plasticizer, a modifier, an antistatic agent, a flame retardant, a dye, and the like. As for the content of them, it is preferable that the content of the reinforcing material be from 0 to 200 parts by mass relative to 100 parts by mass of the polyalkylene terephthalate resin (A), and the total content of the additives except for the reinforcing material be from 0.1 to 60 parts by mass relative to 100 parts by mass of the polyalkylene terephthalate resin (A).

As for the method for producing the polyester resin composition according to the present invention, the above-described components and, if necessary, various additives can be mixed together and melt-kneaded. The method for melt-kneading can be any method that is well known to a person skilled in the art, and a single-screw extruder, a twin-screw extruder, a pressure kneader, a Banbury mixer, and/or the like can be used. Among these, a twin-screw extruder is preferably used.

The method for molding the thermoplastic resin composition according to the present invention is not particularly limited, and a known method such as injection molding, gas-assisted molding, heating/cooling cycle molding, blow molding, extrusion molding, and/or the like can be used to obtain a molded product. Among these, from the viewpoint of versatility, injection molding is preferable.

### EXAMPLES

In the following, the present invention will be described in further detail by way of Examples, but the below Examples do not limit the scope of the present invention. It should be noted that the measured values described in the Examples were measured in the manner described below.

### [Method for Resin and Mold Release Agent Evaluation]

### (1) Reduced Viscosity of Polyalkylene Terephthalate Resin

A resin in an amount of 0.1 g was dissolved in 25 ml of a mixed solvent of phenol/tetrachloroethane (mass ratio, 6/4), and subjected to measurement with the use of an Ubbelohde viscometer tube at 30° C. (unit, dl/g)

### (2) Thermogravimetric Analysis of Mold Release Agent

On a thermogravimetric analyzer (trade name “EXSTAR6000”, manufactured by Hitachi High-Tech Science Corporation), on a weight detection mode, 10 mg of a sample was measured at a temperature raising rate of 20° C./minute within a temperature range of room temperature to 450° C. From the measurement results, the weight decrement rate at 300° C. was read.

### [Method for Molded Product Evaluation]

### (1) Mold Releasability

### (Mold-Release Resistance Value)

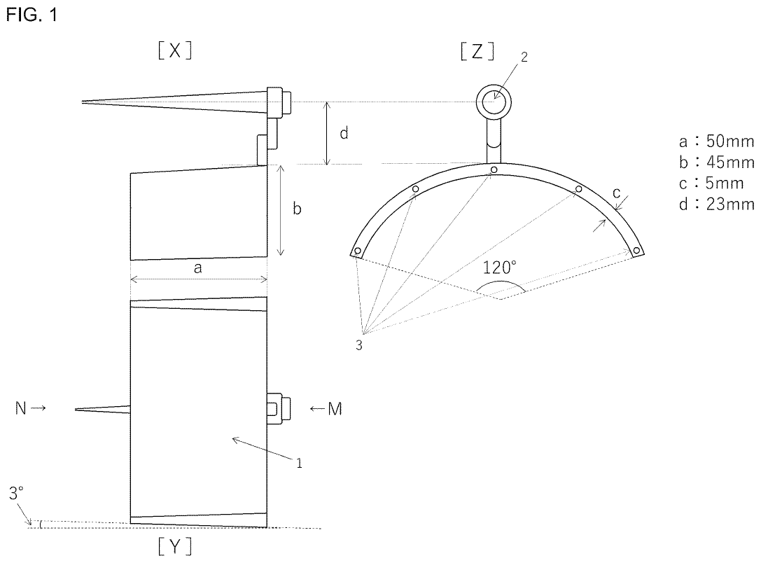

Evaluation of mold relcasability was carried out using an arch-shaped molded product illustrated in FIG. 1, which had a width of 50 mm, a thickness of 5 mm, a central angle of 1200, and a draft of 3°. The cavity of the inner side of the arch had a surface that was mirror-polished with a #12000 file, and mold release was designed to occur when the product was ejected in the direction of shear stress applied to this surface. The mold used here was provided with five ejector pins at positions spaced 30° from each other within a central angle of 120°, where each ejector pin was an ejector-pin-type pressure sensor (trade name “MOLD MARSHALLING SYSTEM SSE Series”, manufactured by FUTABA CORPORATION), which was connected to an amplifier (trade name “MOLD MARSHALLING SYSTEM MPS08”, manufactured by FUTABA CORPORATION) used for measuring pressure at the time of mold release and which had a tip with a diameter of 2 mm. With the use of an injection molding machine (trade name “EC100N”, manufactured by Toshiba Machine Co., Ltd.), under the conditions of a cylinder temperature of 260° C., a mold temperature of 50° C., and a cooling duration of 10 seconds, ejecting force at the time of mold release (a mold-release resistance value) was measured. Among the measured values obtained by the five, sensor-equipped ejector pins, the greatest mold-release resistance value was regarded as the mold-release resistance value at that level. The smaller the mold-release resistance value is, the better the mold releasability is. The arch shape reduces the influence of adhesion that can occur as the resin shrinks, allowing for enhanced accuracy of evaluation of mold release agents. When the mold-release resistance value exceeds 80 MPa, the molded product tends to have dents made by the ejector pins, deformation, and mold release wrinkles, so the mold releasability can be rated as poor.

(State of Dents made by Ejector Pins, and State of Mold Release Wrinkles)

The state of dents on the molded product made by ejector pins and the state of mold release wrinkles on the mirror-polished surface, which can degrade productivity or can be problematic at the time of molding a molded product having a complex shape, were visually examined and rated in three tiers.

Good: No dents made by the ejector pins or mold release wrinkles were observed.

Fair: No dents made by the ejector pins were observed, but mold release wrinkles were observed.

Insufficient: Dents made by the ejector pins were observed.

### (2) Fogging

A phenomenon called fogging can be sometimes problematic, which is a phenomenon where an additive contained in an automotive interior material is volatilized inside a car at high temperatures and then condenses on the inner side of a window pane, which is cold due to the outside air, to make it cloudy and impair visibility. A material that readily causes fogging tends to leave residues on the mold or in the dryer at the time of injection molding, potentially leading to impaired quality of the molded product and lower productivity.

Evaluation of such fogging was carried out in the manner described below.

With the use of an injection molding machine (trade name “EC100N”, manufactured by Toshiba Machine Co., Ltd.) and a mold that had one of its sides mirror-polished with a #14000 file, injection molding was carried out under the conditions of a cylinder temperature of 260° C. and a mold temperature of 50° C., and from the resulting molded product (100 mm×100 mm×2 mmt (thickness)), a plurality of fragments each with a size of about 30 mm×30 mm were cut out. Then, 10 g of these fragments in total were placed in a glass tube (@ 65 mm× height 80 mm) the bottom of which was covered with aluminum foil, and this glass tube was placed upright on a hot plate (trade name “Neo Hot Plate HT-1000”, manufactured by As One Corporation). Further, the glass tube was covered with a slide glass (78 mm×76 mm×1 mm) without leaving any gaps, and then heat treatment was carried out on the hot plate at 180° C. for 20 hours. As a result of the heat treatment, a degradation product sublimated from a polyester resin composition was deposited on and adhered to the interior wall of the slide glass, and the haze value of the slide glass was measured with the use of a haze meter (trade name “NDH2000”, manufactured by Nippon Denshoku Industries). The haze value is determined from the proportion of diffuse transmission light to total transmission light, and can be regarded as an index of cloudiness (%). The smaller the haze value (the more transparent), the better the low-fogging properties of the polyester resin composition.

### (3) Bleeding Out

A phenomenon called bleeding out can be sometimes problematic, which is a phenomenon where an additive contained in an automotive interior material oozes out on the surface after being used for a long time and/or in high-temperature environments, leading to poor appearance and/or sticky surface.

Evaluation of such bleeding out was carried out in the manner described below.

With the use of an injection molding machine (trade name “EC100N” manufactured by Toshiba Machine Co., Ltd.) and a mold that had one of its sides mirror-polished with a #14000 file, injection molding was carried out under the conditions of a cylinder temperature of 260° C. and a mold temperature of 50° C., and the resulting molded product (100 mm×100 mm×2 mmt (thickness)) was subjected to heat treatment with a known hot-air dryer at 160° C. for 24 hours, followed by visual examination of the state of the surface of the molded product to evaluate bleeding-out resistance, by rating the state of whitening and/or color irregularities in three tiers.

### (Evaluation Criteria for Bleeding-Out Resistance)

Good: Almost no whitening or color irregularities were observed.

Fair; Minimal level of whitening and/or color irregularities was observed.

Insufficient: Marked level of whitening and/or color irregularities was observed.

Components used in Examples and Comparative Examples are listed below.

### [Polyalkylene Terephthalate Resin (A)]

a-1: Polybutylene terephthalate resin (manufactured by TOYOBO Co., Ltd., with a reduced viscosity of 0.83 dl/g)
a-2: Polyethylene terephthalate resin (manufactured by TOYOBO Co., Ltd., with a reduced viscosity of 0.63 dl/g)

### [Mold Release Agent (B)]

b-1: Dipentaerythritol hexastearate (manufactured by Emery Oleochemicals

Japan Ltd, LOXIOL VPG2571, with a weight decrement rate at 300° C. of 4.3%)
b-2: Glycerol tri-12-hydroxystearate (manufactured by Riken Vitamin Co., Ltd., Rikemal TG-12, with a weight decrement rate at 300° C. of 1.3%)
b-3: Montanic acid pentaerythritol tetraester (manufactured by Clariant Chemicals Co., Ltd., Licolub WE40 P, with a weight decrement rate at 300° C. of 5.2%)
b-4: Dipentaerythritol hexastearate (manufactured by Riken Vitamin Co., Ltd., Rikestar L-8483, with a weight decrement rate at 300° C. of 5.0%)
b-5: Montanic acid partially saponified wax (manufactured by Clariant Chemicals Co., Ltd., Licowax OP P)

### [Carbon Black (C)]

### C: Carbon Black (Manufactured by Sumika Color Co., Ltd., Black EPC-8E313)

The combination of components specified in Tables 1 and 2 were blended together and kneaded in a co-rotating twin-screw extruder that was set at a cylinder temperature of 250 to 260° C., and the resulting strands were cooled with water and formed into pellet. The pellet thus obtained was dried at 130° C. for 4 hours, and thereby a polyester resin composition of each of Examples and Comparative Examples was obtained. The resulting polyester resin composition was subjected to the above-described molded product evaluations (1) to (3).

TABLE 1

| | | | | Unit | Ex. 1 | Ex. 2 | Ex. 3 | Ex. 4 | Ex. 5 |
|---|---|---|---|---|---|---|---|---|---|
| Composition | A | (a-1) Polybutylene terephthalate resin | | Parts | 100 | 80 | 80 | 80 | 80 |
| | | | | by mass | | | | | |
| | | (a-2) Polyethylene terephthalate resin | | Parts | | 20 | 20 | 20 | 20 |
| | | | | by mass | | | | | |
| | B | (b-1) Dipentaerythritol hexastearate | | Parts | 0.3 | 0.3 | 0.2 | | |
| | | | | by mass | | | | | |
| | | (b-2) Glycerol tri-12-hydroxystearate | | Parts | 0.1 | 0.1 | | 0.1 | 0.2 |
| | | | | by mass | | | | | |
| | | (b-3) Montanic acid pentaerythritol | | Parts | | | 0.2 | | 0.2 |
| | | tetraester | | by mass | | | | | |
| | | (b-4) Dipentaerythritol hexastearate | | Parts | | | | 0.3 | |
| | | | | by mass | | | | | |
| | | (b-5) Montanic acid partially | | Parts | | | | | |
| | | saponified wax | | by mass | | | | | |
| | (C) Carbon black | | | Parts by | 0.5 | 0.5 | 0.5 | 0.5 | 0.5 |
| | | | | mass | | | | | |
| Properties | | Mold | Mold-release | MPa | 78 | 68 | 70 | 68 | 78 |
| | | releasability | resistance value | | | | | | |
| | | | State of dents made by | — | Good | Good | Good | Good | Fair |
| | | | ejector pins, and state | | | | | | |
| | | | of mold release wrinkles | | | | | | |
| | | Fogging | Haze | % | 4 | 4 | 5 | 5 | 4 |
| | | Bleed out | Surface state | — | Good | Good | Good | Good | Good |

TABLE 2

| | | | | | Comp. | Comp. | Comp. | Comp. | Comp. | Comp. | Comp. | Comp. |
|---|---|---|---|---|---|---|---|---|---|---|---|---|
| | | | | Unit | Ex. 1 | Ex. 2 | Ex, 3 | Ex. 4 | Ex. 5 | Ex. 6 | Ex. 7 | Ex. 8 |
| Composition | A | (a-1) Polybutylene terephthalate resin | | Parts | 100 | 100 | 80 | 80 | 80 | 30 | 80 | 80 |
| | | | | by mass | | | | | | | | |
| | | (a-2) Polyethylene terephthalate resin | | Parts | | | 20 | 20 | 20 | 20 | 20 | 20 |
| | | | | by mass | | | | | | | | |
| | B | (b-1) Dipentaerythritol hexastearate | | Parts | 0.4 | | 04 | | | | | |
| | | | | by mass | | | | | | | | |
| | | (b-2) Glycerol tri-12-hydroxystearate | | Parts | | 0.4 | | 0.4 | | | | |
| | | | | by mass | | | | | | | | |
| | | (b-3) Montanic acid pentaerythritol | | Parts | | | | | 0.4 | | | 0.1 |
| | | tetraester | | by mass | | | | | | | | |
| | | (b-4) Dipentaerythritol hexastearate | | Parts | | | | | | 0.4 | | |
| | | | | by mass | | | | | | | | |
| | | (b-5) Montanic acid partially | | Parts | | | | | | | 0.3 | 0.2 |
| | | saponified wax | | by mass | | | | | | | | |
| | (C) Carbon black | | | Parts | 0.5 | 0.5 | 0.5 | 0.5 | 0.5 | 0.5 | 0.5 | 0.5 |
| | | | | by mass | | | | | | | | |
| Properties | | Mold | Mold-release | MPa | 82 | 90 | 72 | 85 | 80 | 81 | 73 | 78 |
| | | releasability | resistance value | | | | | | | | | |
| | | | State of dents made by | — | Fair | Insuff- | Good | Insuff- | Fair | Fair | Good | Fair |
| | | | ejector pins, and state | | | icient | | icient | | | | |
| | | | of mold release wrinkles | | | | | | | | | |
| | | Fogging | Haze | % | 5 | 3 | 5 | 3 | 5 | 6 | 3 | 4 |
| | | Bleed out | Surface stato | — | Good | Good | Good | Good | Good | Fair | Insuff- | Fair |
| | | | | | | | | | | | icient | |

As is clear from Tables 1 and 2, in Examples 1 to 5 which adopted a predetermined formulation, the synergistic effect of enhancing mold releasability attributed to the combined use of mold release agents was exhibited and thereby mold releasability was excellent, and also low-fogging properties and bleeding-out resistance were excellent.

In Comparative Examples 1 and 2 where only one type of mold release agent was used, mold releasability was insufficient, while in Example 1 where mold release agents were used in combination according to a predetermined formulation, the synergistic effect of enhancing mold releasability was exhibited.

Comparative Example 3 was practically acceptable, while in Examples 2, 3 where mold release agents were used in combination according to a predetermined formulation, the synergistic effect of enhancing mold releasability was exhibited. From these results, it can be said that by adopting a predetermined formulation, it is possible to provide a composition in which the amount of mold release agent(s) is reduced and which is more advantageous in low-fogging properties and bleeding-out resistance.

In Comparative Examples 4, 5 where only one type of mold release agent was used, mold releasability was insufficient.

In Comparative Example 6 where only one type of mold release agent whose weight decrement rate at 300° C. was outside the preferable range was used, mold releasability and low-fogging properties are relatively poor.

In Comparative Example 7 where a predetermined fatty acid ester was not used, bleeding-out resistance was relatively poor.

In Comparative Example 8, the mold-release resistance value was comparable to those in Examples 1 and 5, but in Example 1 where fast-solidifying polybutylene terephthalate was used as a polyalkylene terephthalate, the skin layer was formed fast and mold release wrinkles were not formed. In Example 5 and Comparative Example 8, polyethylene terephthalate was used in addition to polybutylene terephthalate, so solidification was slower and thereby mold release wrinkles were observed; however, in Example 5 where a predetermined combination of fatty acid esters were used, bleeding out was reduced, so further enhancement of mold releasability can be attainable by properly adjusting the amount of mold release agent(s). It should be noted that in Comparative Example 8, two types of mold release agents were used but they are not a predetermined combination of fatty acid esters, so the synergistic effect of enhancing mold releasability which can be exhibited by a combined use of mold release agents was not exhibited and, rather, the mold releasability effects of individual mold release agents were simply added up, and, as a result, bleeding-out resistance was relatively poor. It can be said that simple adjustment of the addition amount is less likely to provide a composition having both mold releasability and bleeding-out resistance.

### INDUSTRIAL APPLICABILITY

According to the present invention, it is possible to provide a polyester resin composition that has excellent mold releasability due to the synergistic effect of enhancing mold releasability exhibited by a combined use of mold release agents, and that has less residues left in a dryer and/or on a mold due to reduction of gas production at the time of drying and/or at the time of molding, allowing for enhanced productivity; and a molded product thereof is excellent in low-fogging properties and bleeding-out resistance, and therefore is capable of meeting the demands for complex and/or partially-thin shapes required for smaller automobile parts and electrical/electronic components.

### REFERENCE SIGNS LIST

M movable side of mold
N fixed side of mold
1 mirror-polished surface
2 position of ejector pin not equipped with sensor
3 position of ejector pin equipped with sensor

1. A polyester resin composition comprising 0.01 to 4 parts by mass of a mold release agent (B) relative to 100 parts by mass of a polyalkylene terephthalate resin (A), wherein the mold release agent (B) contains two or more fatty acid ester compounds each consisting of a polyhydric aliphatic alcohol and a fatty acid.

2. The polyester resin composition according to claim 1, wherein the mold release agent (B) includes a fatty acid ester compound (B1) consisting of a hexahydric aliphatic alcohol and a fatty acid having 5 to 30 carbon atoms as well as a fatty acid ester compound (B2) consisting of a dihydric to tetrahydric aliphatic alcohol and a fatty acid having 5 to 30 carbon atoms.

3. The polyester resin composition according to claim 2, wherein the fatty acid ester compound (B1) has a weight decrement rate at 300° C. in thermogravimetric analysis of 4.5% or less.

4. The polyester resin composition according to claim 2, wherein the fatty acid ester compound (B2) has a weight decrement rate at 300° C. in thermogravimetric analysis of 1.5% or less.

5. The polyester resin composition according to claim 2, wherein the fatty acid ester compound (B2) is a fatty acid ester compound consisting of glycerol and a fatty acid having 5 to 30 carbon atoms.

6. The polyester resin composition according to claim 5, wherein the fatty acid ester compound (B2) is a fatty acid triester compound consisting of glycerol and a fatty acid having 12 to 30 carbon atoms.

7. The polyester resin composition according to claim 2, wherein the fatty acid ester compound (B1) is a fatty acid ester compound consisting of dipentaerythritol or tetraglycerol and a fatty acid having 5 to 30 carbon atoms.

8. The polyester resin composition according to claim 7, wherein the fatty acid ester compound (B1) is a fatty acid hexaester compound consisting of dipentaerythritol and a fatty acid having 12 to 30 carbon atoms.
